(19) United States
(12) Patent Application Publication
(10) Pub. No.: US 2011/0124332 A1
(43) Pub. Date: May 26, 2011

(54) System and method for load balancing among multiple base stations using network initiated handovers

(75) Inventors: Honghai Zhang, Ewing, NJ (US); Lily Zhu, Parsiappny, NJ (US); Yang Yang, Morris Plains, NJ (US)

(73) Assignee: Alcatel-Lucent USA Inc.

(21) Appl. No.: 12/591,633

(22) Filed: Nov. 25, 2009

(51) Int. Cl. H04W 36/34

(52) U.S. Cl. 455/434

(57) ABSTRACT

The present invention relates to a system and method for load sharing among multiple base stations using Network Initiated Handover (NIHO). In one embodiment, the method includes computing scores for qualified pairs of candidate mobile station and target base station for potential network initiated handover (NIHO), and selecting a pair of candidate mobile station and target base station based on the computed scores to handover the candidate mobile station of the selected pair from the serving base station to the target base station of the selected pair.

### BACKGROUND

Base stations in wireless communication systems provide wireless connectivity to users within the geographic area, or cell, associated with the base station. The wireless communication links between the base station and each of the users typically include one or more downlink (or forward) channels for transmitting information from the base station to the mobile station and one or more uplink (or reverse) channels for transmitting information from the mobile station to the base station. However, with respect to 4G technologies (e.g., WiMax or LTE), only one communication link exists to/from a user equipment.

Depending on the number and quality of the uplink and downlink channels between base stations and mobile stations as well as the positions of mobile stations, some base stations become overloaded while other base stations become under-loaded. For example, the available resources of a base station are largely dependent on the number of mobile stations being served by that base station and the radio frequency (RF) condition of each base station. When a particular base station is servicing an increased number of mobile stations, the base station may become overloaded. When an overload condition occurs in a base station, the overloaded base station will experience higher call load and service flow blocking probability, as well as extended delay and jitter, for example. As a result, the overall system carries less mobile stations, which leads to less revenue for operators.

In order to prevent a base station from becoming overloaded, the base station may share a certain number of mobile stations with neighboring base stations using Network Initiated Handovers (NIHOs) in order to reduce its load. The process of transferring mobile stations from one base station to other base stations may be referred to as “load sharing” or “load balancing” among multiple base stations. However, directing a mobile station to a different base station during a connection may involve hard handover, which causes traffic interruption. Therefore, any load balancing actions of the base station must be weighted against traffic continuity.

### SUMMARY

The present invention relates to a system and method for load balancing among multiple base stations using Network Initiated Handover (NIHO) to reduce the load on a base station and balance the system load among neighboring base stations.

Example embodiments of the present application provide a method for load balancing among multiple base stations. The method includes computing scores for qualified pairs of candidate mobile station and target base station for potential network initiated handover (NIHO), where the candidate mobile station is within a coverage area of a serving base station. The method further includes selecting a pair of candidate mobile station and target base station based on the computed scores to handover the candidate mobile station of the selected pair from the serving base station to the target base station of the selected pair.

In one embodiment, the method may further include determining if the pairs of candidate mobile station and target base station are qualified for NIHO based on at least one precondition.

In one embodiment, the at least one precondition may include: a quality indicator of the target base station is equal to or greater than a first threshold plus a margin, where the first threshold is a threshold used by the candidate mobile station to initiate a handover when the quality indicator of the serving base station is less than the first threshold; and/or a loading of the serving base station is greater than or equal to a second threshold; and/or a difference between the loading of the serving base station and a loading of the target base station is greater than or equal to a third threshold, where both the loading of the serving base station and the target base station include a loading caused by the candidate mobile station; and/or the candidate mobile station is not dormant; and/or the candidate mobile station contains non-best effort (BE) traffic.

In one embodiment, the method may further include handing over the candidate mobile station of the selected pair from the serving base station to the target base station of the selected pair.

Each score for the qualified pairs of candidate mobile station and target base station is based on a maximum of a loading of the serving base station after the potential NIHO and a loading of the target base station after the potential NIHO. Also, each score for the qualified pairs of candidate mobile station and target base station is based on a minimum of a loading of the serving base station after the potential NIHO and a loading of the target base station after the potential NIHO. Further, each score for the qualified pairs of candidate mobile station and target base station is based on a difference between an occupancy of the candidate mobile station at the serving base station and an occupancy of the candidate mobile station at the target base station.

In another embodiment, each score for the qualified pairs of candidate mobile station and target base station is x+a*x*y+b*(O_{S}−O_{T}), where x is a minimum of O_{S} and L_{S}−L′_{T} and y is a maximum of O_{S} and L_{S}−L′_{T}, a and b are parameters ranging from 0 to 1, O_{S} is an occupancy of the candidate mobile station at the serving base station, O_{T} is an occupancy of the candidate mobile station at the target base station, L_{S} is a loading of the serving base station before the potential NIHO, and L′_{T} is a loading of the target base station after the potential NIHO.

Example embodiments of the present invention also include a system for load balancing among multiple base stations. The system includes a base station that is configured to compute scores for qualified pairs of candidate mobile station and target base station for potential network initiated handover (NIHO), and select a pair of candidate mobile station and target base station based on the computed scores to handover the candidate mobile station of the selected pair from the serving base station to the target base station of the selected pair.

The base station may be further configured to determine if the pairs of candidate mobile station and target base station are qualified for handover based on at least one precondition. The at least one precondition may be the same preconditions described above.

The base station may be further configured to hand over the candidate mobile station of the selected pair from the serving base station to the target base station of the selected pair.

The base station may be configured to compute each score for the qualified pairs of candidate mobile station and target base station based on a maximum of a loading of the serving base station after the potential NIHO and a loading of the target base station after the potential NIHO. In addition, the base station may also be configured to compute each score for the qualified pairs of candidate mobile station and target base station based on a minimum of a loading of the serving base station after the potential NIHO and a loading of the target base station after the potential NIHO.

Further, the base station may be configured to compute each score for the qualified pairs of candidate mobile station and target base station based on a difference between an occupancy of the candidate mobile station at the serving base station and an occupancy of the candidate mobile station at the target base station.

In another embodiment, the base station is configured to compute each score for the qualified pairs of candidate mobile station and target base station based on x+a*x*y+b*(O_{S}−O_{T}), where x is a minimum of O_{S} and L_{S}−L′_{T} and y is a maximum of O_{S} and L_{S}−L′_{T}, a and b are parameters ranging from 0 to 1, O_{S} is an occupancy of the candidate mobile station at the serving base station, O_{T} is an occupancy of the candidate mobile station at the target base station, L_{S} is a loading of the serving base station before the potential NIHO, and L′_{T} is a loading of the target base station after the potential NIHO.

### BRIEF DESCRIPTION OF THE DRAWINGS

Example embodiments will become more fully understood from the detailed description given herein below and the accompanying drawings, wherein like elements are represented by like reference numerals, which are given by way of illustration only and thus are not limiting of the present invention, and wherein:

FIG. 1 illustrates a wireless communication system according to an embodiment of the present invention;

FIG. 2 illustrates a method for load sharing among multiple base stations as set forth in a load sharing application according to an embodiment of the present invention; and

FIG. 3 illustrates a process to determine a score for each pair of candidate mobile station and target base station and select a pair of candidate mobile station and target base station for network initiated handovers based on the computed scores.

### DETAILED DESCRIPTION OF EMBODIMENTS

Various embodiments of the present invention will now be described more fully with reference to the accompanying drawings in which some embodiments of the invention are shown. Like numbers refer to like elements throughout the description of the figures.

As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Portions of the present invention and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the invention are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The invention is not limited by these aspects of any given implementation.

The present invention will now be described with reference to the attached figures. Various structures, systems and devices are schematically depicted in the drawings for purposes of explanation only and so as to not obscure the present invention with details that are well known to those skilled in the art. Nevertheless, the attached drawings are included to describe and explain illustrative examples of the present invention. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

Embodiments of the present invention provide a mechanism to allow a base station share its load (e.g., mobile stations) across multiple neighboring base stations using Network Initiated Handovers (NIHOs) based on scores that are assigned to qualified pairs of candidate mobile station and target base station. The candidate station is a mobile station identified as a candidate for a network initiated handover to a neighboring base station (e.g., target base station). As a result, a base station may share a certain number of mobile stations with neighboring base station in order to reduce its load.

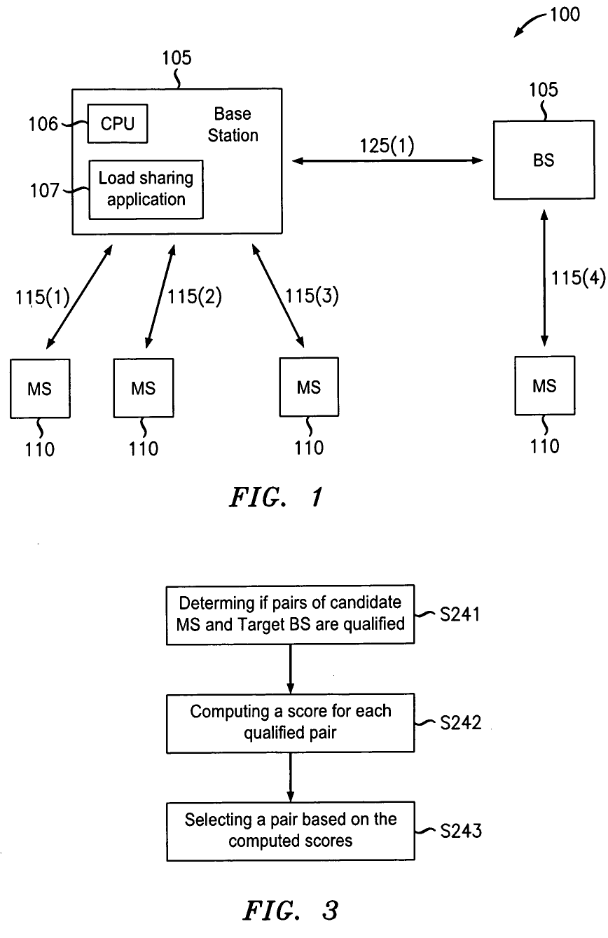

FIG. 1 illustrates a wireless communication system 100 according to an embodiment of the present invention.

The wireless communication system 100 includes base stations 105 that provide wireless connectivity to one or more mobile stations 110 over corresponding air interfaces 115 (e.g., 115(1)-115(4)). However, persons of ordinary skill in the art should appreciate that the present disclosure is not limited to wireless communication systems 100 that use base stations 105 to provide wireless connectivity. In alternative embodiments, the wireless communication system 100 may use other devices to provide wireless connectivity, such as base transceiver stations, base station routers, WiMAX or WiFi access points, access networks, and the like. The mobile station 110 may include but is not limited to a user equipment (EU), a fixed or mobile subscriber unit, a pager, a cellular telephone, a personal digital assistant (PDA), a computer, or any other type of user device capable of operating in a wireless environment.

Techniques for establishing, maintaining, and operating air interfaces 115 to provide uplink and/or downlink wireless communication links between the base stations 105 and the mobile stations 110 are known in the art and in the interest of clarity only, those aspects of establishing, maintaining, and operating the air interfaces 115 that are relevant to the present disclosure will be discussed herein.

The base stations 105 communicate with other base stations 105 in the communication network 100 via a transport network 125(1). Base stations 105 may exchange information regarding their respective loading such as loading updates, configuration changes, and handover messages for incoming handover evaluation, for example. Techniques for establishing, maintaining, and operating the transport network 125(1) to provide communication between base stations 105 are known in the art and in the interest of clarity only, those aspects of establishing, maintaining, and operating the transport network 125(1) that are relevant to the present disclosure will be discussed herein.

One or more base stations 105 include a computer processing unit (CPU) 106 that is configured to carry out instructions according to a load sharing application 107. The load sharing application 107 is stored in a memory storage of the base station 105, which may include any type of computer storage mediums such as Read Only Memory (ROM) and/or Read Access Memory (RAM), for example.

In order to prevent a base station 105 from being overloaded, the base station 105 will proactively institute Network Initiated Handovers (NIHOs) to reduce the number of mobile stations 110 that are served by the base station 105. For purposes of this disclosure, NIHOs may also be referred to as handovers. The number of mobile stations being served by a base station 105 may be referred to as a load of the base station 105. However, load may be measured in other ways such as bandwidth, for example. The load sharing application 107 provides a mechanism for load sharing among multiple base stations in order to reduce the load on a base station to provide increased overall system capacity, which is discussed below.

The load sharing application 107 determines an optimal mobile station and target base station to handover from the base station 105 in order to minimize the total number of NIHOs by using a scoring algorithm for each pair of mobile station 110 and target base station such that all candidates are evaluated based on a set of predefined conditions, and the pair of candidate mobile station and target base station with the highest score will be chosen to perform NIHO.

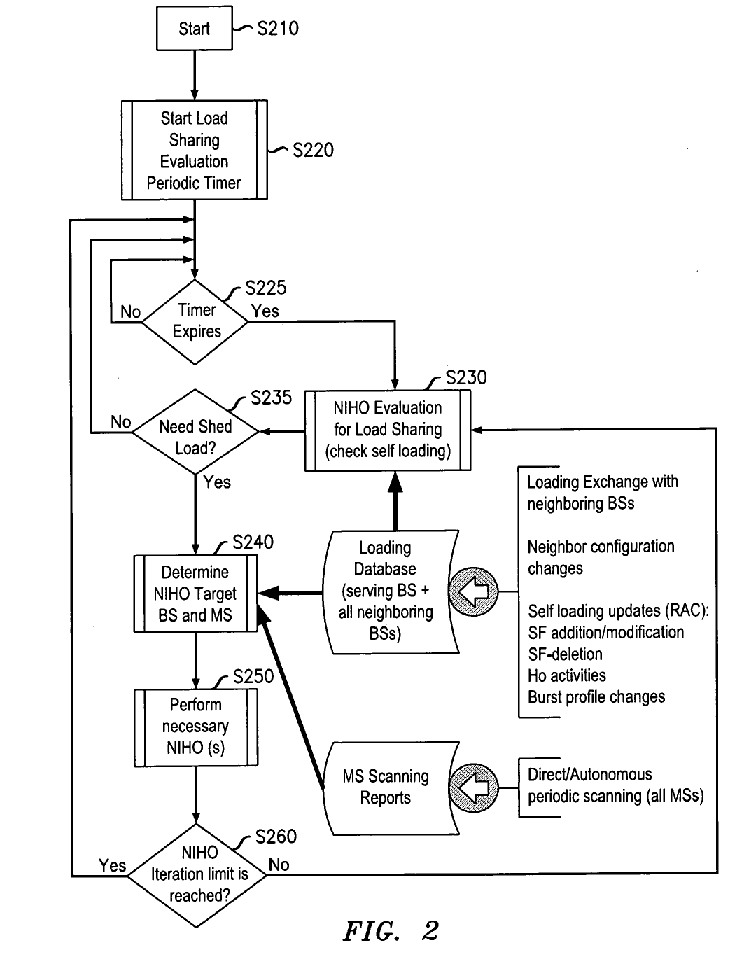

FIG. 2 illustrates a method for load sharing among multiple base stations 105 as set forth in the load sharing application 107 according to an embodiment of the present invention. In step S210, a base station 105 starts the load sharing application 107. In S220, a load sharing evaluation periodic timer is set to control the timing of the load sharing application 107. The period of the load sharing application 107 is a configurable parameter and may be adjusted to suit each particular base station 105. In S225, the timer is checked to determine whether the timer has expired. If the timer has not expired, the application will continue to check until the timer has expired. If the timer has expired, in S230, the base station 105 conducts an NIHO evaluation to determine whether the base station 105 is above a first threshold, which indicates that the base station 105 is in a condition for load sharing.

In S230, the NIHO evaluation includes an evaluation of the loading of the base station 105 to determine if the base station 105 is above a first threshold. The first threshold may be a loading threshold expressed as a radio frequency (RF) load that is used for call admission control. This NIHO evaluation is based on evaluation information loaded into a database of the base station 105. The database may be stored in any type of storage medium in the base station 105 such as ROM and/or RAM memory, for example. Evaluation information may encompass any type of information from base stations 105 necessary to make a determination on whether the base station 105 is above the first threshold. For example, the evaluation information may include loading information for the base station 105 and the target base stations, target base station configuration changes, self loading updates for radio admission control (RAC), service flow (SF) addition/modifications, SF deletions, handover (HO) activities, and/or a burst profile. A burst profile is a profile of a user's RF. For instance, the burst profile usually contains information such as spectral efficiency of the user.

After the NIHO evaluation is complete, in S235, if the NIHO evaluation determines that the base station 105 is above the first threshold, the process proceeds to S240. If the NIHO evaluation determines that the base station 105 is not above the first threshold, the process returns to S225 to determine if the timer has expired.

In S240, the process determines the best possible candidate mobile station and target base station to handover in order to reduce overall system capacity. For example, as discussed below, the base station 105 computes scores for qualified pairs of candidate mobile station and target base station for potential NIHO handover to achieve overall optimized system load after the handover.

The determination in S240 is based on evaluation information described above, and mobile scanning reports from the mobile stations 110. Mobile scanning reports provide signal strengths (SINR) of different target base stations so that the scoring algorithm (discussed below) chooses a candidate base station that can provide connectively to the mobile station. Step S240 is further explained with reference to FIG. 3.

FIG. 3 illustrates a process to determine a score for each pair of candidate mobile station and target base station and select a pair of candidate mobile station and target base station for NIHO based on the computed scores. For example, the candidate mobile station may have three different possible target base stations. In this case, the process in FIG. 3 would determine a score for each possible combination (e.g., (1) candidate mobile station 1−base station 1, (2) candidate mobile station 1−base station 2, and (3) candidate mobile station 1−base station 3), and select the pair with the highest score. Although the above-identified example uses only three different combinations, example embodiments of the present invention encompass many mobile stations and base stations. For example, the base station 105 determines a score for each mobile station 110 that reports other neighboring base stations. However, before a score is computed for each pair of candidate mobile station and target base station, the base station 105 determines if the pairs of candidate mobile station and target base station are qualified in order to reduce the amount of combinations to a manageable number, as described with respect to S241.

In S241, the base station 105 determines if the pairs of the candidate mobile station and the target base station are qualified for network initiated handover based on a set of pre-conditions. For example, a pair of the candidate mobile station and the target base station must meet at least one of the preconditions, as described below, to be determined qualified for possible NIHO to the target base station.

The pre-conditions include that (a) a quality indicator of the target base station is equal to or greater than a second threshold plus a margin δ. The quality indicator may be a Carrier to Interference-plus-Noise Ratio (CINR), for example. The second threshold is a threshold used by the candidate mobile station to initiate a handover when the quality indicator of the base station 105 is less than the second threshold.

The pre-conditions may also include that (b) the loading of the serving base station 105 is greater than or equal to a third threshold. Further, the pre-conditions may also include that (c) the difference between the loading of the serving base station and the target base station (both including the loading caused by the candidate mobile station) is greater than or equal to a fourth threshold. Also, the pre-conditions may include that (d) the mobile station is not in sleep/dormant mode, and (e) the mobile station contains non-Best Effort (BE) traffic. The preconditions in the load sharing application 107 include at least one of the preconditions (e.g., (a), (b), (c), (d) and/or (e)) described above. For example, the preconditions may include any one of the preconditions described above, as well as any combination of preconditions (a), (b), (c), (d) and/or (e).

After determining which pairs of candidate mobile station and target base station are qualified, in S242, the base station 105 computes a score for each of the qualified pair. Each score for the pairs of candidate mobile station and target base station that are determined to be qualified is based on one or more of the following:
L_{S}—Loading of the serving base station before potential handover (HO);
L_{T}—Loading of the target base station before potential HO;
L_{S}′—Loading of the serving base station after potential HO;
L_{T}′—Loading of the target base station after potential HO;
O_{S}—Occupancy of the mobile station at the serving base station, which is the loading caused by the candidate mobile station at the serving base station;
O_{T}—Occupancy of the mobile station at target base station, which is the loading caused by the candidate mobile station at the target BS.

The score for each of the qualified pairs is computed to achieve the following three objectives in order to minimize the number of NIHOs while achieving optimum load balancing results. Objectives 1 and 2 are related to selecting the optimal mobile station and target base station to shed the load, and objective 3 is related to reducing the overall system load after NIHO.

Objective 1 is related to minimizing the maximum loading of the serving base station and target base station after handover. The mathematical form of this objective is to minimize (max (Lₛ′, Lₜ′)). An alternative form is to maximize min(Oₛ, Lₛ−Lₜ′, which can be obtained by subtracting the original objective 1 from the loading of the serving base station Lₛ.

Objective 2 is related to minimizing the minimum loading of the serving base station and target base station after handover. The mathematical form of this objective is to minimize (min(Lₛ′, Lₜ′). An alternative form is to maximize max (Oₛ, Lₛ−Lₜ′), which can be obtained by subtracting the original objective 2 from the loading of the serving base station Lₛ.

Objective 3 is related to maximizing the difference between the user occupancy at the serving base station and that at the target base station. The mathematical form of this objective is to maximize Oₛ−Ot.

According to an embodiment of the present invention, the score may be defined as a linear combination of the above three objectives, which is reproduced below.

x=min(Oₛ, Lₛ−Lₜ′), y=max(Oₛ, Lₛ−Lₜ′)

score=x+a*x*y+b*(Oₛ−Oₜ)

Parameters a and b are configurable parameters ranging from 0 to 1. Although the score for each qualified pair may be computed based on the equation listed above, other types of scoring equations are well within the example embodiments of the present invention.

In S243, a pair of candidate base station and target base station is selected based on the computed scores to perform NIHO (e.g., handover the candidate mobile station of the selected pair to the target base station of the selected pair). In one embodiment, the pair of candidate mobile station and target base station with the maximum score or highest score is chosen for NIHO.

Referring back to FIG. 2, in S250, the base station 105 performs a NIHO on the candidate mobile station by handing over the candidate mobile station of the selected pair to the target base station of the selected pair. The process in S240 and then S250 is repeated for a fixed number of times or until no target base station and mobile station pair satisfies the pre-conditions.

In S260, if the NIHO limit is not reached, the process returns backs to S230 to evaluate whether the base station is above the first threshold. If the NIHO limit is reached, the process returns to S225 to determine whether the timer has expired.

As a result, embodiments of the present invention allow resources of a base station to be pooled to support the overall system load. Because resources are used more efficiently in a pooled situation, the load sharing function across multiple base stations is a desirable resource management feature to improve system capacity of wireless communication systems such as the WiMax system capacity, for example.

Variations of the embodiments of the present invention are not to be regarded as a departure from the spirit and scope of the embodiments of the invention, and all such variations as would be apparent to one skilled in the art are intended to be included within the scope of this invention.

What is claimed is:

1. A method for load balancing among multiple base stations, the method comprising:
computing scores for qualified pairs of candidate mobile station and target base station for potential network initiated handover (NIHO), the candidate mobile station being within a coverage area of a serving base station; and
selecting a pair of candidate mobile station and target base station based on the computed scores to handover the candidate mobile station of the selected pair from the serving base station to the target base station of the selected pair.

2. The method of claim 1, further comprising:
determining if the pairs of candidate mobile station and target base station are qualified for NIHO based on at least one precondition.

3. The method of claim 2, wherein the at least one precondition includes:
a quality indicator of the target base station is equal to or greater than a first threshold plus a margin, wherein the first threshold is a threshold used by the candidate mobile station to initiate a handover when the quality indicator of the serving base station is less than the first threshold.

4. The method of claim 2, wherein the at least one precondition includes:
a loading of the serving base station is greater than or equal to a first threshold.

5. The method of claim 2, wherein the at least one precondition includes:
a difference between the loading of the serving base station and a loading of the target base station is greater than or equal to a first threshold, wherein both the loading of the serving base station and the target base station include a loading caused by the candidate mobile station.

6. The method of claim 2, wherein the at least one precondition includes:
at least one of (1) the candidate mobile station is not dormant, and (2) the candidate mobile station contains non-best effort (BE) traffic.

7. The method of claim 1, further comprising:
handing over the candidate mobile station of the selected pair from the serving base station to the target base station of the selected pair.

8. The method of claim 1, wherein each score for the qualified pairs of candidate mobile station and target base station is based on a maximum of a loading of the serving base station after the potential NIHO and a loading of the target base station after the potential NIHO.

9. The method of claim 1, wherein each score for the qualified pairs of candidate mobile station and target base station is based on a minimum of a loading of the serving base station after the potential NIHO and a loading of the target base station after the potential NIHO.

10. The method of claim 1, wherein each score for the qualified pairs of candidate mobile station and target base station is based on a difference between an occupancy of the candidate mobile station at the serving base station and an occupancy of the candidate mobile station at the target base station.

11. The method of claim 1, wherein each score for the qualified pairs of candidate mobile station and target base station is x+a*x*y+b*(O_{S}−O_{T}), x being a minimum of O_{S} and L_{S}−L′_{T} and y being a maximum of O_{S} and L_{S}−L′_{T}, a and b being parameters ranging from 0 to 1, wherein O_{S} is an occupancy of the candidate mobile station at the serving base station, O_{T} is an occupancy of the candidate mobile station at the target base station, L_{S} is a loading of the serving base station before the potential NIHO, and L′_{T} is a loading of the target base station after the potential NIHO.

12. The method of claim 11, wherein the selecting step selects the pair of candidate mobile station and target base station with a highest score among the scores of the qualified pairs of candidate mobile station and target base station.

13. A system for load balancing among multiple base stations, the system comprising:
a base station configured to compute scores for qualified pairs of candidate mobile station and target base station for potential network initiated handover (NIHO), the candidate mobile station being within a coverage area of a serving base station, and select a pair of candidate mobile station and target base station based on the computed scores to handover the candidate mobile station of the selected pair from the serving base station to the target base station of the selected pair.

14. The system of claim 13, wherein the base station is further configured to determine if the pairs of candidate mobile station and target base station are qualified for NIHO based on at least one precondition.

15. The system of claim 14, wherein the at least one precondition includes:
a quality indicator of the target base station is equal to or greater than a first threshold plus a margin, wherein the first threshold is a threshold used by the candidate mobile station to initiate a handover when the quality indicator of the serving base station is less than the first threshold.

16. The system of claim 14, wherein the at least one precondition includes:
a loading of the serving base station is greater than or equal to a first threshold.

17. The system of claim 13, wherein each score for the qualified pairs of candidate mobile station and target base station is based on a maximum of a loading of the serving base station after the potential NIHO and a loading of the target base station after the potential NIHO.

18. The system of claim 13, wherein each score for the qualified pairs of candidate mobile station and target base station is based on a minimum of a loading of the serving base station after the potential NIHO and a loading of the target base station after the potential NIHO.

19. The system of claim 13, wherein each score for the qualified pairs of candidate mobile station and target base station is based on a difference between an occupancy of the candidate mobile station at the serving base station and an occupancy of the candidate mobile station at the target base station.

20. The system of claim 13, wherein each score for the qualified pairs of candidate mobile station and target base station is x+a*x*y+b*(O_{S}−O_{T}), x being a minimum of O_{S} and L_{S}−L′_{T} and y being a maximum of O_{S} and L_{S}−L′_{T}, a and b being parameters ranging from 0 to 1, wherein O_{S} is an occupancy of the candidate mobile station at the serving base station, O_{T} is an occupancy of the candidate mobile station at the target base station, L_{S} is a loading of the serving base station before the potential NIHO, and L′_{T} is a loading of the target base station after the potential NIHO.
